(19) United States
(12) Patent Application Publication
(10) Pub. No.: US 2023/0313837 A1
(43) Pub. Date: Oct. 5, 2023

(54) BEARING ASSEMBLY

(71) Applicant: AKTIEBOLAGET SKF, GOTEBORG (SE)

(72) Inventors: Ingo Schulz, Gerolzhofen (DE); Lijun CAO, Houten (NL); Christoph ZEUG, Erlangen (DE)

(21) Appl. No.: 18/024,302

(22) PCT Filed: Sep. 2, 2021
(86) PCT No.: PCT/EP2021/074219

§ 371 Date: Mar. 2, 2023

(30) Foreign Application Priority Data
Sep. 9, 2020 (DE) 102020211329.7

(51) Int. Cl. F16C 33/60; F16C 19/16; F16C 33/58

(52) U.S. Cl. CPC F16C 33/60; F16C 19/166; F16C 33/585; F16C 2229/00; F16C 2240/34

(57) ABSTRACT

A bearing assembly includes first and second raceways and balls between the raceways, and is conceptually divided into four quadrants by a ball rotational axis and an axis perpendicular to the ball rotational axis. The second raceway includes a first portion lying in the first quadrant and a second portion lying in the second quadrant, and the first raceway includes a first portion lying in the third quadrant and a second portion lying in the fourth quadrant. Each of the balls has a raceway contact point in each of the quadrants, and a center of curvature of each of the portion of the raceway in each quadrant is located in an opposite quadrant. The contact points are offset from the axis perpendicular to the ball axis of rotation and are arranged in a range of ±10°, around the axis perpendicular to the ball axis of rotation.

The present invention relates to a bearing assembly with a first raceway element and a second raceway element according to patent claim 1.

In high-precision transmissions, in particular in the joints of robots or the bearings of wind turbine blades, the bearings used there must often perform a rotational movement of less than 360° at a low speed. At the same time, a complex load situation can occur with both radial and axial forces, tilting moment loads, and a combination of loads. For this purpose crossed roller bearings are often used that can be used as a single bearing, while with other bearing types two bearings would be necessary. Crossed roller bearings have a high rigidity, a high running accuracy and a low clearance. For crossed roller bearings, cylindrical rollers are used that are inserted between the bearing rings inclined by 45° in alternating succession. Such crossed roller bearings are known both for rotational movement applications and linear movement applications.

However, with cylindrical rollers a sliding, so-called slip, occurs more frequently between the rollers and the raceway surfaces and between the roller side surfaces and the opposing raceway, which can lead to increased wear. A sliding also occurs between the rollers themselves, which leads to spacers being advantageous, which in turn increases the complexity of the bearing and creates an additional expense in the assembling of the bearing. The sliding also leads to a high energy loss in such bearings. Furthermore, in crossed roller bearings an edge stress can occur, in particular under high loads. Although this edge stress can be weakened by special profiles of the raceways, these profiles are always only provided for an individual load case and create a poor load distribution in other load cases. The closer the load direction is to the rotational axis of the roller, the less load is supported by the roller. This results in a situation where, under specific load conditions, the load is carried by only 50% of the available rollers. Furthermore, in some cases due to the alternating positioning of the rollers, half of the rollers may carry more load than the other half, which creates an unevenly distributed loaded zone. The alternating positioning of the rollers also causes an additional effort in the assembling of the bearing, since special mechanisms are required in order to position the rollers.

Other potential solutions to support loads when axial forces dominate are, for example, an axial ball bearing or a four-point contact ball bearing when a bending moment must additionally be supported. However, these bearings also have some disadvantages. Axial ball bearings have a minimal radial load rigidity, and a radial load can lead to an eccentricity between the bearing rings. Due to centrifugal forces, the balls in an axial ball bearing show increased sliding. Since there are only two contact points between the balls and the raceways, this can lead to a high contact pressure. The two contact points between the balls and the raceways change with the load direction, which causes a dynamic change of the ball rotational axis and therefore causes a high and non-constant sliding and therefore a high energy loss.

It is therefore the object of the present invention to provide a bearing assembly that is a stable bearing for radial and axial loads with a low energy loss, and that is cost-effective and simple to manufacture.

This object is achieved by a bearing assembly according to patent claim 1.

The bearing assembly includes a first raceway element and a second raceway element, wherein balls are disposed between the raceway elements. The balls each roll on raceways that are disposed on the raceway elements.

The bearing assembly can be a ball bearing in the form of a radial bearing or an axial bearing or a linear bearing. In the case of a radial bearing, the first raceway element and the second raceway element correspond to the inner ring and the outer ring. In the case of an axial bearing, the inner ring and the outer ring (i.e., the first raceway element and the second raceway element) are referred to as housing disk and shaft disk. In the case of a linear bearing, the first raceway element and the second raceway element correspond to a rail and a carriage.

In order to make possible low sliding and friction losses as well as a high bending rigidity and a low maximum contact pressure with the raceways, the balls each have four contact points with the raceways. This means that each ball has four contact points in total, i.e., two contact points per raceway element. In the contact point, the respective raceway and the ball have the same tangent, and the radius of curvature, i.e., the distance between the centerpoint of the circle of curvature of the raceway curvature and the contact point, stands perpendicular to this tangent. Due to these four contact points, in contrast to other bearings, the contact pressure is divided, and the contact stresses and thus the wear, the friction and other surface damages are thereby reduced.

Conventional four-point contact ball bearings that can be used as axial bearings also have four contact points, but these contact points are only theoretically present. In operation, only two of the four theoretical contact points are active, which thus leads to a high contact pressure at these two active contact points. In contrast thereto, in the bearing assembly proposed here, four contact points are always active, whereby the contact pressure is better distributed. A conventional four-point contact ball bearing furthermore has a reduced contact rigidity both in the axial and in the radial direction since the normal direction of the contact points is not aligned with the axial or the radial axis. Furthermore, such a bearing requires a high axial preload in order to be able to support radial loads.

In order to achieve this, in cross-section the bearing assembly is conceptually divided into four quadrants, which are arranged clockwise, by the rotational axis of a ball and an axis perpendicular to the rotational axis of the ball. Here the rotational axis of the ball is seen as a conceptual rotational axis at standstill. In operation, the rotational axis of the ball is not fixed, but rather can move.

The raceway of the second raceway element lies in the first and the second quadrants, and the raceway of the first raceway element lies in the third and the fourth quadrants. The centerpoint of the radius of curvature of the raceway of the first quadrant lies in the third quadrant, the centerpoint of the radius of curvature of the raceway of the second quadrant lies in the fourth quadrant, the centerpoint of the radius of curvature of the raceway of the third quadrant lies in the first quadrant, and the centerpoint of the radius of curvature of the fourth quadrant lies in the second quadrant. Here each of the four contact points of a ball lies in one of the four quadrants. Due to this special arrangement it is achieved that each ball always has four contact points with its raceways, and these contact points are also maintained under load. With a conventional four-point contact ball bearing, in operation under load only two or at most three contact points are loaded. An axial ball bearing works with only two contact points, and crossed roller bearings also work with only two contact lines. The four contact points thus generate, per contact point with the ball, a lower contact pressure, whereby, for example, the wear of the bearing assembly can be reduced, wherein at the same time due to the arrangement of the contact points, radial and axial loads can be supported.

Due to the use of balls, the assembling of the bearing assembly can be simplified, since in comparison to rollers the balls can be installed without a specific orientation. The use of balls is furthermore advantageous since a ball is a completely symmetrical element that does not require an alternating orientation of the rolling elements as is known from crossed roller bearings. This makes it possible that all rolling elements carry the load between all raceways, even when they work under special conditions, instead of only half of the elements as is the case with crossed roller bearings. Furthermore, balls can rotate freely about their center and can therefore transmit the load over any point of their surface. This utilizes the surface of the balls to a maximum, distributes the contact over the entire ball surface, and thus also distributes the wear over the entire ball surface. In contrast thereto, for example, with crossed roller bearings only some areas of the rolling-element surface are worn.

The bearing assembly described here can be realized as a full complement bearing, without additional wear always occurring at the same point as is the case with roller bearings. Due to the point-shaped ball-ball contact, hardly any wear of the balls arises. However, since the contact points “migrate” on the surface of the balls and thus the same point is not always loaded, this leads to a lower total load for the balls. This is the case since, in contrast to a roller bearing, the orientation of the ball body varies with respect to the rotational axis. Alternatively, a cage can also be used, and it is also possible to use spacers instead of a complete cage. The bearing assembly provides sufficient space in the region along the ball rotational axis in order to use both spacers and a cage.

According to one embodiment, the intersection point of the two radii of curvature of the raceway of the first raceway element lies on an axis perpendicular to the rotational axis of the ball, and the intersection point of the two radii of curvature of the raceway of the second raceway element also lies on an axis perpendicular to the rotational axis of the ball. These axes can also be a common axis, in particular the axis that lies perpendicular to the rotational axis and passes through the centerpoint of the ball. The intersection points can also lie on the rotational axis. Each raceway thus has two radii of curvature whose centerpoints do not coincide, whereby each raceway is comprised of two segments between which there is a transition. The transition between the two raceways or the contact line of the two raceways lies on a plane that passes through the ball centerpoint and is perpendicular to the imaginary ball rotational axis. Due to these two radii of curvature and their special arrangement, it can be ensured that the ball always has four contact points with the raceways. The two radii of curvature can be different or identical.

According to a further embodiment, the radii of curvature are identical. This leads to a symmetric separation of the radii of curvature and their centerpoints on the four quadrants. Due to this symmetric arrangement, the load is uniformly distributed on the four contact points between the balls and the raceways.

According to a further embodiment, the contact points are arranged perpendicular to the rotational axis of the ball, offset with respect to the axis. This means that the contact points are preferably not located on the rotational axis of the ball and on the axis perpendicular to the rotational axis of the ball. In this way, the bearing assembly can be prevented from behaving as an axial or radial ball bearing that has only two contact points, which would reduce the radial or axial rigidity. Furthermore, due to the bearing assembly, radial or axial loads can be supported in a defined manner directly from the beginning of the loading onward, in contrast to a radial or axial ball bearing that has one contact point on each of the raceway elements. In the same manner, axial or radial loads can be supported in a defined manner directly from the beginning of the loading onward, in contrast to a ball bearing that also has only one contact point on one of the axes.

According to a further embodiment, the contact points are arranged in a region of ±20°, preferably ±10°, about the axis that is perpendicular to the rotational axis of the ball. The contact points between the ball and the raceways can vary within this region depending on the application case. Due to this arrangement, the four contact points create a special kinematics of the balls since the rotational axis of the balls, even during a loading, always remains perpendicular to the axis about which the contact points are arranged.

According to one embodiment, the radius of curvature is a variable radius. This means that the respective raceways can be circular-arc raceways, but also ellipses or generally ovals.

The first raceway element and/or the second raceway element can be configured as a divided raceway element, wherein a preload mechanism is provided in order to control the contact points between the ball and the raceways. Due to the preloading of the respective raceway element, the preload of the contact points can be adjusted by an adjusting of the clearance between the parts of the divided raceway element.

The bearing assembly can be realized as an axial bearing, a radial bearing, or a linear bearing. Depending on the respective design of the bearing assembly, the rotational axis of the ball can be perpendicular to the rotational axis of the bearing (in the case of an axial bearing), parallel to the rotational axis of the bearing (in the case of a radial bearing), and perpendicular to the direction of movement (in the case of a linear bearing).

Due to the bearing assembly described here, many different bearing configurations are thus possible that each show the advantages of the bearing assembly as described above. In particular, due to the bearing assembly described here, a good radial load rigidity and a low wear behavior due to a low sliding behavior is provided.

According to a further aspect, a transmission, in particular a high-precision transmission, is provided with a bearing assembly as described above. Such a high-precision transmission can be used, for example, in robots that require a very precise controlling of the movement sequences and therefore of the joints in which bearings are used. The bearing assembly can be used, for example, as a bearing in a robot application in order to connect successive arms or arm parts.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

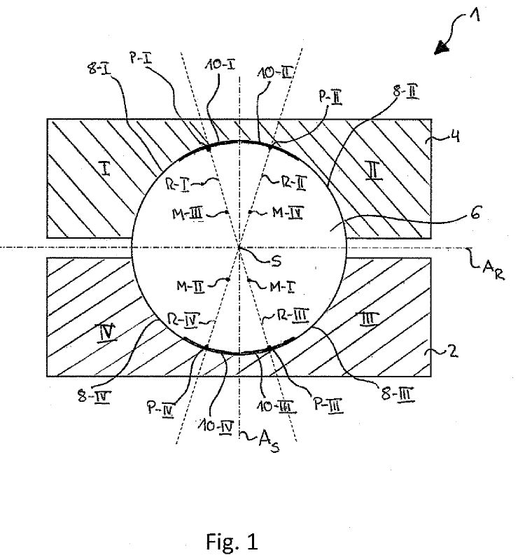

FIG. 1 shows a schematic cross-sectional view of a bearing assembly;

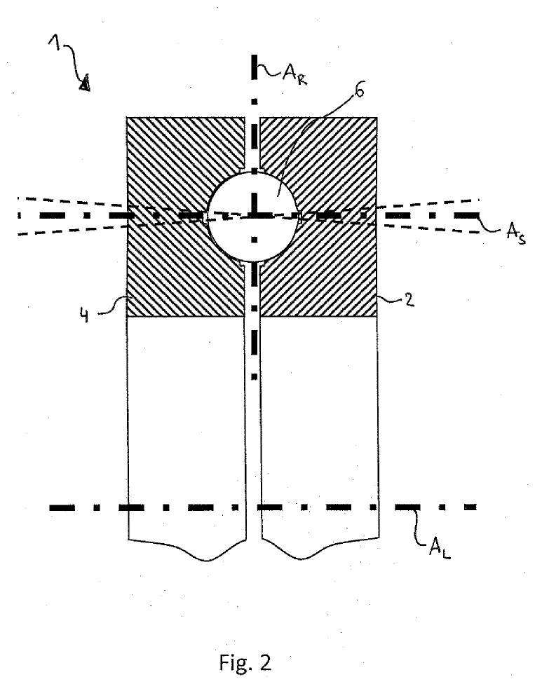

FIG. 2 shows a schematic cross-sectional view of the bearing assembly of FIG. 1 as a single row axial bearing;

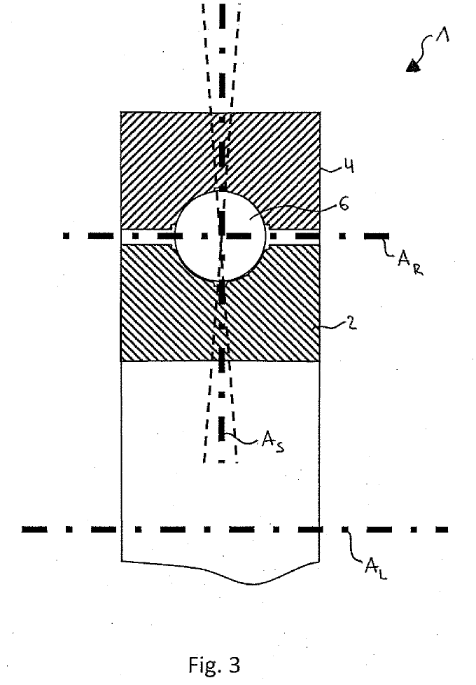

FIG. 3 shows a schematic cross-sectional view of the bearing assembly of FIG. 1 as a single row radial bearing;

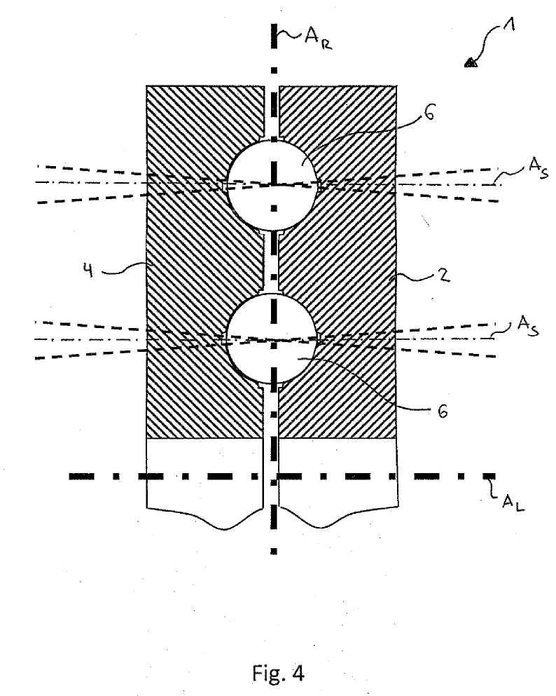

FIG. 4 shows a schematic cross-sectional view of the bearing assembly of FIG. 1 as a double row axial bearing;

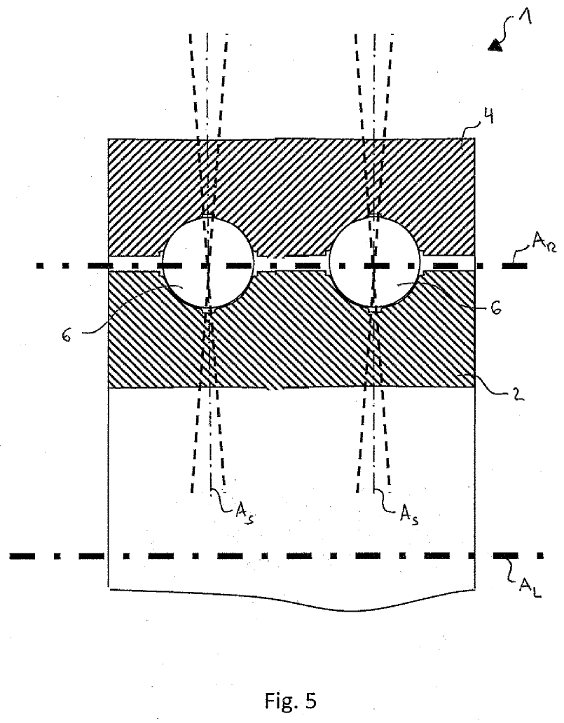

FIG. 5 shows a schematic cross-sectional view of the bearing assembly of FIG. 1 as a double row radial bearing; and

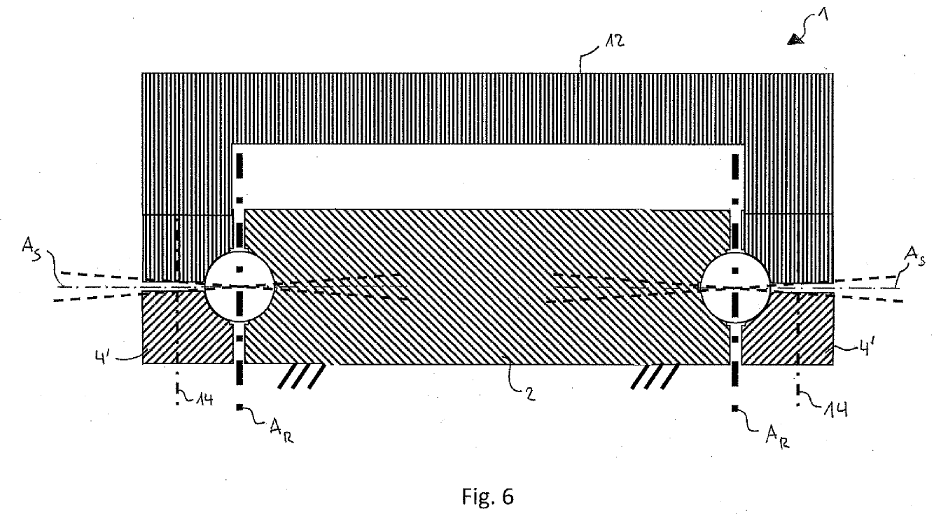

FIG. 6 shows a schematic cross-sectional view of the bearing assembly of FIG. 1 as a linear bearing with divided raceway element.

In the following, identical or functionally equivalent elements are designated by the same reference numbers.

FIG. 1 shows a bearing assembly 1 with a first raceway element 2 and a second raceway element 4. Balls 6 as rolling elements are arranged between the raceway elements 2, 4. The balls 6 roll on raceways 8 that are disposed on the raceway elements 2, 4.

The bearing assembly 1 can be configured as a ball bearing, in particular as a radial or axial bearing, or as a linear bearing. In the case of a radial bearing, the first raceway element 2 and the second raceway element 4 correspond to the inner ring and the outer ring. In the case of an axial bearing, the first raceway element 2 and the second raceway element 4 correspond to the shaft disk and the housing disk. In the case of a linear bearing, the first raceway element 2 and the second raceway element 4 correspond to the rail and the carriage.

In the bearing assembly 1 shown in FIG. 1, the raceways 8 can be conceptually divided into four quadrants I, II, III, IV. The division into the four quadrants I, II, III, IV is effected by the rotational axis A_{R} of the ball and an axis Aₛ that is perpendicular to the rotational axis A_{R}. The raceway of the second raceway element 4 is formed by two segments 8-I, 8-II and lies in the first and second quadrants I, II, and the raceway of the first raceway element 2 is formed by two raceway segments 8-III and 8-IV and lies in the third and fourth quadrants III, IV.

The ball 6 comes in contact with the raceways 8-I, 8-II at two contact points P-I, P-II that are located in two contact zones 10-I and 10-II and with the raceways 8-III and 8-IV at two contact points P-III, P-IV that are located in the contact zones 10-III and 10-IV. In order to ensure that the ball 6 contacts the raceways 8 at the contact points P-I, P-II, P-IV, the raceways 8 have a special design: The centerpoint M-I of the radius of curvature R-I of the raceway segment 8-I lies in the third quadrant III, the centerpoint M-II of the radius of curvature R-II of the raceway segment 8-II lies in the fourth quadrant IV, the centerpoint M-III of the radius of curvature R-III of the raceway segment 8-III lies in the first quadrant I, and the centerpoint M-IV of the radius of curvature R-IV of the raceway segment 8-IV lies in the second quadrant II.

In the embodiment shown in FIG. 1, the intersection point of the radii of curvature R-I, R-II of the first and the second quadrants I, II lies on the axis Aₛ, and the intersection point of the radii of curvature R-III, R-IV of the third and the fourth quadrant III, IV also lies on the axis Aₛ. However, the intersection point can also not lie on the axis Aₛ. Here the radius of curvature R is understood to mean the radius defining the curvature, i.e., the distance between the raceway 8 and the centerpoint M. In particular, as is shown in FIG. 1, the straight line through M-I and M-III intersects the straight line through M-II and M-IV at the intersection point S. In the case shown here, the intersection point S simultaneously lies on the intersection point of the rotational axis A_{R} and the axis Aₛ, but this is not absolutely necessary. Due to this specific design of the radii of curvature R of the raceways 8, it is ensured that the ball 6 contacts the raceways 8 at the contact points P-I, P-II, P-IV. The contact points P-I, P-II, P-IV lie in the contact zones 10 in a region of ±20°, in particular ±10°, about the axis Aₛ.

In order to ensure that the ball bearing 1 can support not only axial or radial loads, the contact points P-I, P-II, P-IV are always offset with respect to the axis Aₛ. In this way the ball 6 always has four contact points P-I, P-II, P-IV with the raceways 8 that each are located in the contact zones 10-I, 10-II, 10-III and 10-IV, whereby a good radial load rigidity and a good load and pressure distribution, and thus a low-wear behavior, are achieved.

The bearing assembly 1 can be used in different configurations, as is shown in FIGS. 2 to 6.

As is shown in FIG. 2, the bearing assembly can be used as a single row axial ball bearing, wherein in this case the rotational axis A_{R} is perpendicular to the bearing rotational axis A_{L}. Here the axis Aₛ about which the contact zones 10-I, 10-II, 10-III, 10-Iv are arranged lies parallel to the rotational axis A_{L} of the bearing.

Alternatively the bearing assembly 1 can be used as a single row radial bearing as is shown in FIG. 3. In this case the rotational axis A_{R} is parallel to the rotational axis A_{L} of the bearing 1. The axis Aₛ, about which the contact zones 10-I, 10-II, 10-III and 10-Iv are arranged is in this case perpendicular to the bearing rotational axis A_{L}.

The bearing assembly 1 can also be used as a double row axial ball bearing (FIG. 4) or as a double row radial ball bearing (FIG. 5). In the case of a double row axial ball bearing, the rotational axis A_{R} is perpendicular to the bearing rotational axis A_{L}, and in the case of a double row radial ball bearing, the rotational axis A_{R} is parallel to the bearing axis A_{L}.

In the case of such a double row axial or radial ball bearing, the inner or outer rings 2, 4 can be configured as divided rings (not shown). In this case, a preload mechanism, for example, a screw connection, can be used in order to control the contact points P-I, P-II, P-IV or contact zones 10 between the ball 6 and the raceways 8. Due to the preloading of the respective ring 2, 4, the preload of the contact points P-I, P-II, P-IV can be adjusted by an adjusting of the clearance between the parts of the divided ring 2, 4. Single row axial or radial ball bearings can also be realized with divided rings 2, 4 and preload mechanisms.

The bearing assembly 1 can also be used as a linear bearing as is shown in FIG. 6. In this case the first raceway element 2 is formed by a rail and the second raceway element by a carriage 12 and an element 4′ separated therefrom. Also in this case the second raceway element 4′ can be adjusted in its preload or its clearance by a preload element 14 in order to correspondingly adjust the contact points P-I, P-II, P-IV or the contact zones 10-I, 10-II, 10-III, 10-IV. In the case of the linear bearing 1 of FIG. 6, the ball rotational axis A_{R} is perpendicular to the direction of movement of the bearing 1 in the carriage 12.

Due to the ball bearing described here, a good radial and axial load rigidity and a low-wear behavior due to a lower friction can be achieved.

### REFERENCE NUMBER LIST

1 Bearing assembly
2 First raceway element
4 Second raceway element
6 Balls
8 Raceways
Contact zones
12 Carriage
14 Preload mechanism
I, II, III, IV Quadrants
A_{L} Bearing rotational axis
A_{R} Ball rotational axis
A_{S} Axis perpendicular to the ball rotational axis
M Centerpoint of the radius of curvature
P Contact points
R Radius of curvature
S Intersection point

1-10. (canceled)

11. A bearing assembly comprising:
a first raceway element having a first raceway,
a second raceway element having a second raceway, and
a plurality of balls disposed between the first raceway and the second raceway,
wherein the bearing assembly is conceptually divided into four quadrants by a rotational axis of one of the plurality of balls and an axis perpendicular to the rotational axis of the one of the plurality of balls,
wherein the second raceway includes a first portion lying in the first quadrant and a second portion lying in the second quadrant, and the first raceway includes a first portion lying in the third quadrant and a second portion lying in the fourth quadrant,
wherein the one of the plurality of balls has a first contact point with the first portion of the second raceway and a second contact point with the second portion of the second raceway, and a third contact point with the first portion of the first raceway and a fourth contact point with the second portion of the first raceway,
wherein a centerpoint of a radius of curvature of the first portion of the second raceway lies in the third quadrant and a centerpoint of a radius of curvature of the second portion of the second raceway lies in the fourth quadrant and a centerpoint of a radius of curvature the first portion of the first raceway lies in the first quadrant and a centerpoint of the radius of curvature of the second portion of the first raceway lies in the second quadrant,
wherein the first, second, third and fourth contact points are offset from the axis perpendicular to the axis of rotation of the one of the plurality of balls, and
wherein the first, second, third and fourth contact points are arranged in a range of ±10° around the axis perpendicular to the axis of rotation of the ball.

12. The bearing assembly according to claim 11,
wherein an intersection point of the radius of curvature of the first portion of the second raceway and the radius of curvature of the second portion of the second raceway lies on the axis perpendicular to the rotational axis of the ball, and
wherein an intersection point of the radius of curvature of the first portion of the first raceway and the radius of curvature of the second portion of the first raceway lies on the axis perpendicular to the rotational axis of the ball.

13. The bearing assembly according to claim 12,
wherein the radius of curvature of the first portion of the second raceway and the radius of curvature of the second portion of the second raceway and the radius of curvature of the first portion of the first raceway and the radius of curvature of the second portion of the first raceway are identical.

14. The bearing assembly according to claim 13,
wherein the radius of curvature of the first portion of the second raceway and/or the radius of curvature of the second portion of the second raceway and/or the radius of curvature of the first portion of the first raceway and/or the radius of curvature of the second portion of the first raceway is non-constant.

15. The bearing assembly according to claim 14,
wherein the first raceway element and/or the second raceway element is a divided raceway element, and
wherein the bearing assembly includes preload means for controlling locations of the first and second contact points and/or for controlling the locations of the third and fourth contact points.

16. The bearing assembly according to claim 14,
wherein the first raceway element is an inner ring or a shaft disk, and
wherein the second raceway element is an outer ring or a housing disk.

17. The bearing assembly according to claim 15,
wherein the rotational axis of the one of the plurality of balls is perpendicular or parallel to a rotational axis of the ball bearing.

18. The bearing assembly according to claim 14,
wherein the bearing assembly is a linear bearing,
wherein the first raceway element is a rail, and
wherein the second raceway element is a carriage.

19. The bearing assembly according to claim 11,
wherein the radius of curvature of the first portion of the second raceway and the radius of curvature of the second portion of the second raceway and the radius of curvature of the first portion of the first raceway and the radius of curvature of the second portion of the first raceway are identical.

20. The bearing assembly according to claim 11,
wherein the radius of curvature of the first portion of the second raceway and/or the radius of curvature of the second portion of the second raceway and/or the radius of curvature of the first portion of the first raceway and/or the radius of curvature of the second portion of the first raceway is non-constant.

21. The bearing assembly according to claim 11,
wherein the first raceway element and/or the second raceway element is a divided raceway element, and
wherein the bearing assembly includes preload means for controlling locations of the first and second contact points and/or for controlling the locations of the third and fourth contact points.
